(19) United States
(12) Patent Application Publication
(10) Pub. No.: US 2005/0079977 A1
(43) Pub. Date: Apr. 14, 2005

(54) Liquid composition for promoting plant growth, which includes nano-particle titanium dioxide

(76) Inventors: Kwang-Soo Choi, Jeonju (KR); Sang-Hoon Lee, Iksan (KR); Hyoung-Song Choi, Jeonju (KR)

Correspondence Address: PARK & SUTTON LLP, 3255 WILSHIRE BLVD, SUITE 1110, LOS ANGELES, CA, 90010, US

(21) Appl. No.: 10/500,069

(22) PCT Filed: Nov. 16, 2002
(86) PCT No.: PCT/KR02/02142

(30) Foreign Application Priority Data
Jan. 15, 2002 (KR) 2002-0002388

(51) Int. Cl. A01N 25/00

(52) U.S. Cl. 504/116.1

(57) ABSTRACT

The present invention relates to a liquid composition for promoting plant growth, which contains titanium dioxide nanoparticles. The composition contains, as a main component, an aqueous solution containing titanium dioxide colloids. The titanium dioxide nanoparticles have such a particle size that they can be readily absorbed to plants. A pH of the aqueous solution is adjusted in order to prevent rapid precipitation of the titanium dioxide nanoparticles in the aqueous solution, before the aqueous solution is diluted with water such that titanium dioxide has a desired concentration. Also, the composition contains adjuvants necessary for plant growth and a surfactant for dispersion. The composition allows crop yield to be increased by increasing the photosynthetic efficiency of plants, and permits increasing the bactericidal activity of plants against plant pathogens. Furthermore, the composition permits improving a problem of environmental contamination caused by the excessive use of biochemical fertilizers, and also contributes to an increase in farmer income.

### TECHNICAL FIELD

The present invention relates to a liquid composition for promoting plant growth, which contains titanium dioxide nanoparticles. More particularly, the present invention relates to a liquid composition for promoting plant growth, which has a bactericidal action against pathogen, partially provides nutrients and constituting substances for plants, and permits increasing the solar energy utilization efficiency of plants in a plant photosynthesis process, significantly increasing crop yield.

### BACKGROUND ART

Currently, a problem to be solved in an agricultural field is to minimize land devastation and environmental contamination caused by over-application of various chemicals used for the increased production of foods.

Methods for promoting plant growth according to the prior art can be broadly divided into two ones.

A first method which utilizes chemical fertilizers temporarily seems to be effective, but ultimately deteriorates the conditions of the soil on which plants grow. Thus, a vicious circle arises in that fertilizers must be applied again in order to improve the deteriorated soil conditions. As a result, this method is not preferred in a long-term view.

A second method utilizes plant growth regulators which are plant extracts or similar substances which are artificially synthesized.

A method is known which utilizes N-acylalanine derivatives, indole acetic acid, gibberellin, benzylaminopurine, indolebutyric acid, or a mixture thereof. However, this method is expensive and has a handling problem in that an alcohol solvent must be used. Also, this involves limitations causing chemical injury to plants.

Moreover, the use of these substances provide some growth promoting effects, but shows a side effect and inevitably involves a damage caused by the improper use of chemicals. Plants must adapt to the surrounding circumstance in order to regulate in vivo metabolism of plants. Nevertheless, the method limited only to the growth of plants results in a reduction of productivity and even killing of plants.

Meanwhile, Korean Patent No. 10-0287525 (entitled “plant growth promoter”) discloses a plant growth promoter which utilizes 2-methyl-4-dimethylaminomethyl-5-hydroxybenzimidazole, thereby inhibiting mutation, preventing oxidation and increasing resistance to disease.

The above chemical fertilizer and the plant growth promoter consist mostly of artificially synthesized organic substances which have various components. Thus, even when the same is used, a result varying depending on the condition of use is obtained.

Recently, there was an attempt to substitute the chemical fertilizer with natural inorganic substances containing composite ingredients. However, this shows an insufficient effect while it seems that much damage will be caused by mixed heavy metals.

Meanwhile, there were attempts to develop new agents for promoting plant growth by using functions of known substances. However, they showed an insufficient effect, a reduced economical efficiency and a limited application range.

### DISCLOSURE OF INVENTION

The present invention relates to a liquid composition for promoting plant growth, which contains titanium dioxide nanoparticles. The present invention comprises finding new substances which promotes growth and metabolism of plants and at the same time, not causes a problem of environmental contamination. In addition, it comprises conducting an optimized application test for plants.

Factors necessary for plant growth include nutrient, moisture, temperature, light and the like. Plant growth when other conditions are the same is determined by the amount of the most deficient inorganic element according to the law of minimum nutrient. Although optimizing a feed rate of inorganic elements for each of various plants is necessary, but it is actually difficult since soil or the surrounding environmental conditions for growing plants vary.

Therefore, deviating from the conventional formality of combinations of organic fertilizers with inorganic elements, the present inventors have made an attempt to find a new substance which has been not used hitherto.

On the basis of the fact that plants grow while obtaining the nutrients from the substances synthesized by photosynthesis based on solar energy, the present inventors have attempted to find the substances capable of utilizing solar energy.

As a substance consistent with the above object, the present inventors have found photocatalytic titanium dioxide (TiO₂), which has a guaranteed safety for a human body and plants, and functionalities including sterilization and decomposition of poisonous organisms, and is formed of easily available materials.

By photocatalyst, it is meant to be a substance which helps chemical reaction to occur by absorbing light of a necessary wavelength range from sunlight or artificial illumination.

Such a photocatalytic substance has a function of oxidizing the poisonous substances into carbon dioxide (CO₂) and water (H₂O) using oxygen (O₂) and water (H₂O) as oxidants under light irradiation.

As photocatalyst, titanium dioxide is recently highlighted, which is relatively inexpensive, not photodecomposed, can be used in a semi-permanent manner and does not cause a problem of environmental contamination.

Also, in advanced industrial nations including Japan, Europe and America, titanium dioxide was applied in home and industrial sections for antibiosis, deodorization, air cleaning and like, and is increasingly enlarged with respect to its use.

Based on this point, the present inventors have first discovered a manner of applying photocatalytic titanium dioxide directly to plants.

The titanium dioxide nanoparticles according to the present invention were prepared in such a manner that it is readily available to plants in a colloidal state, whereas prior inorganic fertilizers including lime and siliceous fertilizers are not readily available to plants since they are in a solid state.

It is known that the prior lime or siliceous fertilizers, etc., are mostly transferred through soil, slowly solubilized by organic acids in soil or acids secreted from crop roots, and then available to plants by absorption.

However, the above inorganic fertilizers have a shortcoming in that their active ingredients are hardly soluble in water, and form complexes with aluminum (Al) and iron (Fe), etc., as microelements in soil, so that the absorption efficiency by crops is lowered.

In order to solve this problem, since fertilizers need to be applied in an amount larger than an amount available to plants and a overnutrition state is ultimately caused, plants may be disadvantageously grown in a non-normal manner.

In the present invention, a method of applying titanium dioxide as a main component directly to the foliages of crops is used so that an absorption pathway to crops is expanded to soil and foliages.

Titanium dioxide can be divided into three types consisting of anatase, rutile and brookite according to its crystal lattice structure, and has a feature in that its catalytic activity highly varies depending on the respective crystal structures.

Among these structures, the rutile structure has weak photocatalytic activity and thus is used for an assistant purpose including UV blocking. The anatase and brookite structures are known to have relatively high catalytic activity, but their functions are found to be infinitely varying according to preparation methods.

Furthermore, the photocatalytic activity is closely connected with the crystal structure and also with the particle size and specific surface area of titanium dioxide. Generally, it is known that, as the particle size is decreased, the specific surface area is increased and the number of contact point for activity is increased so that the ability of titanium dioxide to decompose organisms and serve as catalysts are more excellent.

Currently, commercially available photocatalysts are mostly used in a state where photocatalyst powders are suspended in a solution, and in a state where a sol solution of titanium dioxide is supported on or into a carrier.

Typical methods for preparing the photocatalyst powders include a method where inorganic titanium salt, such as titanium chloride or titanium sulfate, is hydrolyzed, neutralized with a base, mixed with a water soluble metal slat at a given weight ratio and calcined at high temperature. Also, a sol-gel method using organic titanium precursor is included.

Among these methods, the sol-gel method utilizes organic titanium alkoxide as a starting material, so that it allows a particle size to be uniform and a crystal structure to be adjusted according to reaction conditions in a smooth manner, as compared to other methods. For this reason, the sol-gel method is typically preferred.

In the present invention, titanium dioxide of all varieties as described above may be used.

Using titanium alkoxid as a starting material, the titanium dioxide nanoparticles of a particle size ranging from 3 to 200 nm was crystallized to obtain an anatase-type structure as a stable dispersion. Test results for the catalytic activity of the obtained dispersion indicated that the dispersion was completely comparable with commercially available titanium dioxide sol solutions, and the use of the dispersion could provide a more excellent growth promoting effect.

Where the anatase-type titanium dioxide dispersion obtained as described above is diluted with water to a suitable titanium dioxide concentration, mixed with methylene blue as organic pigment, and then left to stand under sunlight, an organic decomposition process of the photocatalyst can be visually observed. Where plant pathogens are present in the dispersion and approach to the surface of the photocatalyst, they can be decomposed by the action of a hydroxy radical, in the same manner as the pigment.

However, functions of the photocatalyst in water are obviously different from function of the photocatalyst applied to crops. The present inventors have made an attempt to apply the titanium dioxide photocatalyst to plants by solving the following technical problems.

First, after recording a concentration of titanium dioxide diluted with water, there was made an attempt to determine a minimum concentration at which the decomposition of organisms can occur.

The present inventors have observed the activity of titanium dioxide in water. Results indicate that, as the concentration of the titanium dioxide in water is decreased, the activity is reduced and then little or no activity exhibits.

As a result, it was found that the activity exhibits even at a concentration of less than 10 ppm. This suggests that titanium dioxide at this low concentration can sufficiently exploit its functions without causing damage to the intracellular mechanism, such as a chloroplast, which is the center of plant photosynthesis, and also titanium dioxide can be used in an agricultural section at relatively low costs.

Second, if nanoparticle titanium dioxide diluted with water is applied to crops, water will be evaporated with the passage of time and the portion of unabsorbed titanium dioxide will remain on the surface of crops as solids. The existing substances when completely absorbed to plants exhibit its functions, but titanium dioxide was found to make plants resistant to external stress by the portion of titanium dioxide unabsorbed by plants and also to have positive effects in that it shows a bactericidal and defensive effects against various phytopathogens.

Third, since titanium dioxide has an isoelectric point of about pH 4 which but varies according to circumstances, it maintains a stable colloidal form at the acidic and alkaline ranges. If the titanium dioxide nanoparticles are diluted with water, they then gradually approach to the isoelectric point with an increase in dilution times and are ultimately changed into the form of precipitates. The present inventors have found that the effect of titanium dioxide was highly increased when it was applied to foliages after its pH was adjusted such that titanium dioxide could be not precipitated within at least two hours after dilution.

Moreover, it was found that, as the particle size was decreased during a procedure of preparing the titanium dioxide nanoparticle, the precipitating time was delayed.

From the above results, the photocatalytic titanium dioxide nanoparticle was found to be suitable as a main component of the plant growth and metabolism promoting composition that is the object of the present invention.

It was found that, when the titanium dioxide nanoparticle after diluted with water was applied to crops, it promoted the growth of crops and also exhibited a bactericidal action against phytopathogens. In addition, some of the titanium dioxide particles provide nutrients and constituent substances for plants and it increases the efficiency of solar energy utilization of plants in a photosynthesis process of plants, thereby significantly increasing crop yield. Based on these points, the present invention was achieved.

The liquid composition for promoting plant growth which contains the titanium dioxide nanoparticles according to the present invention is formed as follows.

In the composition for promoting plant growth containing nanoparticle titanium dioxide, a main component of the composition is an aqueous solution containing colloidal titanium dioxide, and titanium dioxide has such a particle size that it can be readily absorbed to plants. Also, in order to prevent the rapid precipitation of titanium dioxide in the aqueous solution, a pH of the solution is adjusted. Moreover, the solution is diluted with water such that titanium dioxide is adjusted to a desired concentration. In addition, adjuvants necessary for plant growth are added and a surfactant for dispersion is added.

The present inventors have selected a photocatalytic titanium dioxide nanoparticle solution as a material for promoting growth and metabolism of plants, and discovered a manner capable of simply utilizing the solution by diluting it with water in order to allow it to be usefully available to plants.

The titanium dioxide solution has an anatase-type structure, which is commercially readily available and has a relatively high photocatalytic activity and a particle size ranging from 3 to 200 nm.

When the titanium dioxide nanoparticles are diluted with water and applied to plants, a portion of the nanoparticles are then absorbed to plants so as to promote the internal photosynthetic mechanism and metabolism of plants. The remaining portion of titanium dioxide which was not absorbed by plants remains on the surface of plants so that it serves to increase resistance of plants against various stresses and pathogens.

For the above object, a variety of titanium dioxide nanoparticles can be used. Although the nanoparticles of a particle size of 3 to 200 nm have excellent absorption and workability and shows an excellent increase in crop yield, a solution in which fine particles of several tens of microns are dispersed may also be used.

As long as titanium dioxide particles can stably maintain a dispersed state, any titanium dioxide particles may be used whether it is primary particles in a monodispersed state or secondary particles formed by aggregation of the primary particles, as observed with a scanning electron microscope.

Moreover, although the particles of various shapes may be used, it is preferred for the present invention to use the sphere-, needle- or plate-shaped titanium dioxide nanoparticles.

Meanwhile, although the crystal structure of titanium dioxide used for the above purpose may be anatase-type, rutile-type, brookite-type or a mixture thereof, the anatase-type crystal structure is particularly preferred.

The anatase-type crystal structure is excited by absorbing light of a near-ultraviolet region of about 380 nm wavelengths from sunlight, and at the same time, exhibits strong oxidation power by separation of electrons from holes such that it decomposes most of poisonous organisms. For this reason, it is believed to be a crystal structure which is most consistent with the above object.

When the colloidal titanium dioxide is diluted with water and applied to crops, the number of its diluted times will have a great effect on crop yield.

In the present invention, the concentration of titanium dioxide nanoparticles after final dilution is 1 to 1,000 ppm, preferably 3 to 300 ppm and more preferably 3 to 150 ppm.

If the concentration is above 1,000, economic costs will be increased while a possibility of chemical injury will be rather increased. If the concentration is below 1 ppm, the effect of the titanium dioxide nanoparticles will be rapidly reduced.

Since the titanium dioxide dilution when applied to the foliage of crops shows the highest increase in crop yield, it basically differs from the existing soil conditioners.

Since the titanium dioxide nanoparticle which is the main component of the composition according to the present invention acts to highly increase the crop yield by itself, it shows a sufficient growth promoting effect without mixing with separate assistant additives. However, it is obvious to those skilled in the art that fertilizer ingredients necessary for the growth of plants, other metallic or non-metallic oxides, or surfactants used as an absorber or a spreader, may be added.

Oxides of Li, Be, B, Na, Mg, Al, Si, P, K, Ca, Sc, V, Cr, Mn, Fe, Co, Ni, Cu, Zn, Ga, Ge, Se, Zr or a mixture thereof may be used as the fertilizer ingredients or metallic or non-metallic oxides. Furthermore, as long as the materials containing the above elements are dissolved in water and can be absorbed by plants, carbonates, chlorides, nitrates or sulfates of the above elements may also be used.

The amount of adding of the metallic or non-metallic oxides are 0.1 to 20% by weight, and preferably 0.5 to 15% by weight, relative to the titanium dioxide solids that are the main components of the liquid composition according to the present invention.

A bactericidal effect shown by the titanium dioxide nanoparticle solution is due to the oxidation strength of semiconductor which causes when illuminating directly or indirectly sunlight. For this reason, under the condition having the blocking of sunlight or the nighttime having little or no radiation of sunlight, the bactericidal effect will be deteriorated.

Based on this point, the present inventors have found that silver (Ag) nanoparticles having the ability to make phytopathogens extinct by contacting with the phytopathogens can be used as another adjuvant.

Generally, the silver nanoparticles having a particle size of 1 to 100 nm are stably dispersed in an aqueous solution. If the silver nanoparticles after added to the titanium dioxide solution is applied, the ability of the titanium dioxide is then further increased due to high bactericidal activity of the silver nanoparticles. Moreover, the silver nanoparticle which is an expensive substance is difficult to apply to agricultural crops alone, but when mixed with the nanoparticle titanium dioxide, it exhibits excellent bactericidal activity only at the minimum quantity.

Although the amount of adding of the silver nanoparticles may be selected within a range at which economical efficiency is ensured, the present inventors have found that it is preferably in the range of 0.5 to 20% by weight, and more preferably 1.0 to 10% by weight, relative to the titanium dioxide solids.

In the present invention, the surfactant which may be added to the aqueous titanium dioxide solution and used as an absorber or spreader includes a cationic surfactant, a nonionic surfactant, an anionic surfactant, and an ampotheric surfactant. The kind of surfactant used varies depending on the kind of plants to which the titanium dioxide solution is added.

One or two kinds or more of the surfactants as described above are mixed at a suitable ratio and added to the aqueous titanium dioxide solution. In this case, the amount of adding of the surfactants is preferably 0.1 to 5% by weight, and more preferably 0.2 to 1% by weight, relative to the titanium dioxide solids.

### BRIEF DESCRIPTION OF THE DRAWINGS

FIG. 1 is a graph showing the culm growth effect of a rice plant treated with the liquid composition for promoting plant growth according to the present invention.

### BEST MODE FOR CARRYING OUT THE INVENTION

The present invention will hereinafter be described in further detail by examples. It should however be borne in mind that the present invention is not limited to or by the examples.

### EXAMPLE 1

### Preparation of Liquid Composition for Promoting Plant Growth Containing Titanium Dioxide

In this example, a liquid composition for promoting plant growth is prepared using titanium dioxide nanoparticles.

This composition is characterized in that it contains the titanium dioxide nanoparticles of 3 to 200 nm.

As organic titanium alkoxide which is a starting material of titanium dioxide according to the present invention, TTIP (Titanium-Tetraisopropoxide, JUNSEI, 97%) was used. 240 ml of 70% nitric acid was 8.94 liters of deionized water.

To this solution, 720 ml of TTIP was added dropwise. The mixture was stirred under reflux at 80° C. to be hydrolyzed.

At the reaction was terminated, a blue titanium dioxide colloidal solution was obtained. Titanium dioxide solids: 2.0%, pH=7.0.

The crystal structure of the titanium dioxide colloids was found to be an anatase-type as observed with XRD. Also, more than 95% of the titanium dioxide nanoparticles were present in the particle size range of 15 to 25 nm. 300 ml of 70% nitric acid was added to the titanium dioxide colloidal solution so that the solution was adjusted to pH 0.5.

To this solution, 7990 liters of water was added so that the concentration of titanium dioxide became 25 ppm.

This solution (sample A) was used as an application solution to plants.

Application Test

The sample A obtained in Example 1 was provided as an solution to be applied to plants, and rice and corn plants were selected as objects to be applied with the sample A. In the case of the rice plants, in order to examine a change in crop yield according to an environmental change, those grown on a PET vessel in a laboratory were compared to those grown directly on open fields.

Also, the sample was applied to individuals whose tillering had been completed, such that the effect of a difference between tillers on crop yield could be eliminated.

In order to verify the plant growth promoting effect of the titanium dioxide nanoparticles which were applied to the respective crops, the rice plants were recorded for their culm length, weight, grain weight and thousand grain weight (i.e., weight per thousand kernels), and the corn plants were recorded for the weight of individuals after harvesting.

In order to verify the bactericidal and defensive abilities of the titanium dioxide nanoparticles contained in the sample A, two species of phytopathogens were selected and tested according to a screening method provided by Korea Research Institute of Chemical Technology.

### Test Example 1

### Test of Effect of Composition According to Example 1 in Rice Plants

Rice plants whose tillering had been completed under the same condition were planted on a PET vessel, and solutions after divided into a sample A and a control were applied to the rice plants and examined for their effect.

TABLE 1
Results measured for weight of rice plants
grown in PET vessel and for grain weight

| | Total | Weight | Total | Yield crop |
|---|---|---|---|---|
| | weight of | increase | weight of | increase |
| | rice plant | relative to | grain | relative to |
| | (average, g) | control (%) | (average, g) | control (%) |
| Sample A | 119.1 | 21.6 | 19.2 | 44.4 |
| Control | 97.9 | 0.0 | 13.3 | 0.0 |

In Table 1, the sample A where the titanium dioxide solution prepared by the sol-gel method described in Example 1 was diluted and applied to plants exhibits a more than 20% increase in weight as compared to the control, due to the growth promoting effect of the titanium dioxide nanoparticles. Particularly, the total weight of grains was increased by more than 40% as compared to the control. This suggests that an increase in crop yield of the sample A as compared to that of the control is significant.

### Test Example 2

### Test of Effect of Composition According to Example 1 in Rice Plants

Rice plants whose tillering had been completed were planted on the open fields, and solutions after divided into a sample A and a control were applied to the rice plants and examined for their effect.

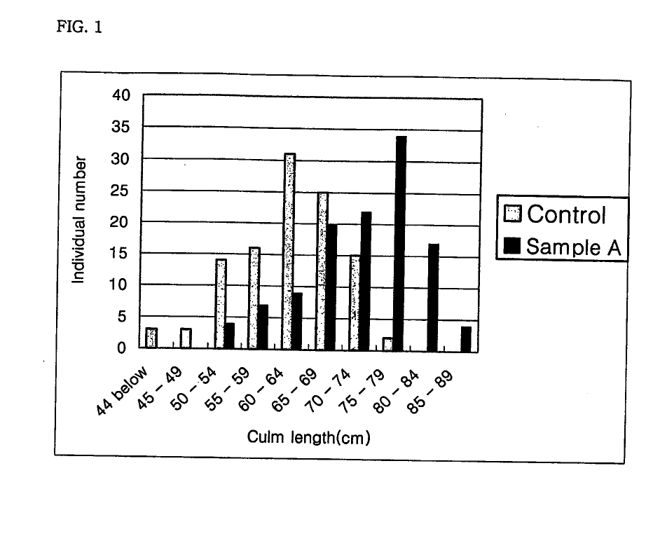

FIG. 1 indicates that when the titanium dioxide solution (sample A) was applied, the culm length was increased by about 13% as compared to the control. In the state of the rice plants at harvesting, the sample A exhibited good erectness and light interception, similarly to the control, and thus it showed little or no lodging.

TABLE 2
Results measured for weight of rice plants
grown in open field and for grain weight

| | Total | Weight | Total | Yield crop |
|---|---|---|---|---|
| | weight of | increase | weight of | increase |
| | rice plant | relative to | grain | relative to |
| | (average, g) | control (%) | (average, g) | control (%) |
| Sample A | 145.06 | 39.9 | 205.2 | 31.8 |
| Control | 103.66 | 0.0 | 155.7 | 0.0 |

Table 2 indicates that when the titanium dioxide solution was applied on an open field, crop yield was increased by more than 30%, as in the case of the PET vessel.

TABLE 3
Results measured for hull ratio and thousand
grain weight in rice grown on open field

| | Thousand grain weight (g) | Ratio of hull in grain |
|---|---|---|
| Sample A | 24.22 | 17.2 |
| Control | 24.38 | 17.9 |

Table 3 shows thousand grain weight and hull ratio in the grains which were harvested on an open field in order to analyze a crop yield-increasing effect of the titanium dioxide solution. The sample A exhibited the thousand grain weight and the hull ratio in grains which are similar to those of the control. This suggests that crop yield was increased due to an increase in the number of grains other than an increase in grain weight.

Also, FIG. 1 shows a 13% increase in culm length, and Table 2 shows a 31.8% increase in grain weight. This indicates that when the titanium dioxide-containing solution was applied, not only the length was increased but also the metabolism was promoted such that the grains could be yielded at a larger amount.

### Test Example 3

### Test of Composition of Example 1 on Corn Plants

The sample A and the control were separately applied to feed corn plants grown on an open field, and examined for their effect.

TABLE 4
Result measured for weight and increase in
yield of corn plants

| | Total weight of corn plants | Increase in yield relative |
|---|---|---|
| | (average, g) | to control |
| Sample A | 3,670 | 46.1 |
| Control | 2,511 | 0.0 |

Table 4 indicates that when the titanium dioxide nanoparticles were applied to feed corn plants as field crops, crop yield could be increased by more than 40%. These results verify the growth promoting effect and metabolism promoting effect of the titanium dioxide nanoparticles, although these results can somewhat vary since only the weight of the harvested corn plants is measured.

### Test Example 4

### Bactericidal Test

In order to verify the bactericidal activity and defensive ability against phytopathogens of the titanium dioxide nanoparticles used in a foliar application solution according to the present invention, a test was carried out according to a screening method provided by Korea Research Institute of Chemical Technology.

In the test, Pyricularia oryzae (RCB) and Botrytis cinerea (TGM) were used as the phytopathogens, and a primary screening method was conducted as follows.

For rice blast, a Magnaporthe grisea KJ201 cell line as a pathogen was first inoculated to a rice bran agar medium (Rice Polish 20 g, Dextrose 10 g, Agar 15 g, distilled water 1 L) and cultivated in an incubator at 25° C. for two weeks.

The surface of the medium in which the pathogen had been grown was scratched with Rubber Polishman to remove aerial hypha. The medium was left to stand on a shelf at 25-28° C. for 48 hours under fluorescent light to form spores. In inoculating with pathogen, conidia were suspended in sterile distilled water to a conidium suspension of a concentration of 106 conidia/ml which was then sufficiently sprayed on rice plants (2-3 normal leaf stage) treated with chemicals, such that it could be dropped down.

The inoculated rice plants was left to stand on a moist-chamber in a dark state for 24 hours, after which they were diseased in a constant temperature and moisture chamber at a relative humidity of more than 80% and 26° C. for 7 days and examined for infected leaf area.

Meanwhile, for tomato gray mold, Botrytis cinerea as a pathogen was inoculated to a potato agar medium, cultured in an incubator at 25° C. for 7 days, and further cultured for 7 days while maintaining a 12 hours light/12 hours dark cycle every day, thereby forming spores.

In inoculating with disease, the conidia formed in the medium were collected as potato dextrose broth, and treated with a hemacytometer so as to have a conidium concentration of 106 conidia/ml. Then, they were inoculated to young tomato plants (2-3 leaf stage) treated with chemicals. The inoculated tomato plants were decreased on a moist chamber at a relative humidity of more than 95% and at 20° C. for 3 days, and examined for infected leaf area.

In treating with the titanium dioxide solution, the solution was diluted with water to a titanium dioxide concentration of 100 ppm. Four solutions divided into two for each of diseases were disposed on a table and applied to plants with a spray gun (1 kg/cm²) with rotation such that they could be uniformly attached to the entire plants. Then, the plants were grown on a greenhouse and inoculated with pathogens.

TABLE 5
Result measured for protective value for rice
blast and tomato gray molding

| | | Protective value (%) | |
|---|---|---|---|
| | Titanium | | Tomato gray mold |
| KSC No. | concentration (ppm) | Rice blast (RCB) | (TGM) |
| 47314 | 100 | 78 | 17 |

The titanium dioxide solution applied as described above exhibited high bactericidal activity against rice blast, and also showed weak bactericidal activity against tomato gray mold.

TABLE 6
Comparison of protective value of Titanium
dioxide solution with general bactericidal agent

| | | Concentration | Protective value |
|---|---|---|---|
| Plant disease | Control agents | (ppm) | (%) |
| Rice blast (RCB) | Blasticidin-S | 50 | 100 |
| | | 1 | 70 |
| Tomato gray mold | Fludioxonil | 50 | 100 |
| | | 5 | 56 |

Table 6 shows the bactericidal activity and use concentration of control agents used as a bactericidal agent. The titanium dioxide solution of the present invention exhibits bactericidal activity regardless of the kind of pathogens, although it shows a decreased bactericidal activity as compared to the control agents. If plants were not yet attacked with pathogens, the titanium dioxide solution has an advantage in that the portion of titanium dioxide nanoparticles remaining on the plants serves to inhibit the generation of lesion. Particularly, the titanium dioxide solution is advantageous in that it is harmless to organisms.

Namely, the titanium dioxide nanoparticles are applied to plants, they exhibit an effect of promoting plant growth and metabolism while showing bactericidal and defensive activities against plants. Therefore, the plants applied with the titanium dioxide nanoparticles becomes strong against disease and insect pest and also exhibits excellent adaptability to a change in surrounding environment, thereby increasing crop yield.

### Industrial Applicability

As described above, the present invention provides the liquid composition containing the titanium dioxide nanoparticles as a main component.

Where the plant growth promoting composition is applied to plants, a portion of titanium dioxide absorbed by the plants then serves to promote the internal photosynthetic mechanism and metabolism of the plants, while an unabsorbed portion of titanium dioxide remains on the surface of the plants so that it acts to increase resistance of the plants to various pathogens which can be flowed in from the outside. Particularly, the titanium dioxide nanoparticles exhibit bactericidal activity regardless of the kind of pathogens and thus can be used in a wide applicable range.

1. A liquid composition for promoting plant growth, which contains titanium dioxide nanoparticles.

2. A liquid composition for promoting plant growth, which contains titanium dioxide nanoparticles, in which the composition contains, as a main component, an aqueous solution containing titanium dioxide colloids; the titanium dioxide nanoparticles have such a particle size that they can be readily absorbed to plants; a pH of the aqueous solution is adjusted in order to prevent rapid precipitation of the titanium dioxide nanoparticles in the aqueous solution, before the aqueous solution is diluted with water such that titanium dioxide has a desired concentration; and the composition contains adjuvants necessary for plant growth and a surfactant for dispersion.

3. The composition of claim 2, in which the titanium dioxide nanoparticles have a particle size ranging from 3 to 200 nm.

4. The composition of claim 2, in which the titanium dioxide colloids has a crystal structure selected from the group consisting of anatase, rutile, brookite and a mixture thereof.

5. The composition of claim 2, in which a pH of the aqueous solution is adjusted with organic or inorganic acids.

6. The composition of claim 2, in which the aqueous solution is diluted with water such that a titanium dioxide concentration is in the range of 1 to 1,000 ppm.

7. The composition of claim 1, in which the surfactant for dispersion is selected from the group consisting of a cationic surfactant, a nonionic surfactant, an anionic surfactant, an ampotheric surfactant, and a mixture of two or more thereof, which are used at the amount of 0.1 to 5% by weight relative to the titanium dioxide solids.

8. The composition of claim 1, in which the adjuvants necessary for plant growth are in the form of a water soluble salt of one or more element selected from the group consisting of N, P, K, S, Ca, Mg, Fe, Cu, Zn, Mo, Mn and B, which are used at the amount of 0.1 to 20% by weight relative to the titanium dioxide solids.

9. The composition of claim 2, in which the adjuvants necessary for plant growth are silver (Ag) nanoparticles which are used at the amount of 0.5 to 20% by weight relative to the titanium dioxide solids.

10. The composition of claim 2, in which the adjuvants necessary for plant growth are one or more selected from the group consisting of Li, Be, B, Na, Mg, Al, Si, P, K, Ca, Sr, Cr, Mn, Fe, Co, Ni, Cu, Zn, Ga, Ge, Se and Zr, which are used at the amount of 0.1 to 20% by weight relative to the titanium dioxide solids.
